(19) United States
(12) Patent Application Publication
(10) Pub. No.: US 2014/0278636 A1
(43) Pub. Date: Sep. 18, 2014

(54) CADDIE MANAGEMENT SYSTEM

(71) Applicant: Christi Chatmas, Austin, TX (US)

(72) Inventor: Christi Chatmas, Austin, TX (US)

(21) Appl. No.: 14/212,824

(22) Filed: Mar. 14, 2014

Related U.S. Application Data
(60) Provisional application No. 61/786,868, filed on Mar. 15, 2013.
(60) Provisional application No. 61/929,383, filed on Jan. 20, 2014.

(51) Int. Cl. G06Q 10/10

(52) U.S. Cl. CPC G06Q 10/1097
USPC 705/7.14; 705/7.21

(57) ABSTRACT

A request for caddie services at one or more tee times is received over a network. From information stored in a database about two or more caddies, one or more caddies are selected for performing caddie services for the tee times. Over the network, an acceptance or rejection for the assignments for the tee times is received from the selected caddies.

### PRIORITY CLAIM

This application claims priority to U.S. Provisional Application Ser. No. 61/786,868, entitled “CADDIE MANAGEMENT SYSTEM” filed Mar. 15, 2013, and U.S. Provisional Application Ser. No. 61/929,383, entitled “CADDIE MANAGEMENT SYSTEM” filed Jan. 20, 2014, both of which are incorporated herein by reference in their entirety.

### BACKGROUND

1. Field

The present invention relates to the field of managing services. More particularly, aspects of the present disclosure related to systems and methods that can be used to arrange for caddie services over a network.

2. Description of the Related Art

Many golfers rely on caddies to assist them and improve their play. Most golfers do not have a dedicated caddie. As such, a golfer often relies on the club or resort at which the golfer is playing to provide a caddie. Arranging for caddie services at a club or resort in an efficient manner, in a way that satisfies the golfers, may involve a significant amount of work and planning, especially for large resorts and special events, such as tournaments.

### SUMMARY

Systems and methods for managing and providing caddie and other services (for example, at golf courses and other facilities) are described. Caddie services for multiple golf courses may be booked and scheduled over a network. In an embodiment, a request for caddie services at one or more tee times is received over a network. From information stored in a database about two or more caddies, one or more caddies are selected for performing caddie services for the tee times. Over the network, an acceptance or rejection for the assignments for the tee times is received from the selected caddies.

In an embodiment, system includes a processor and a memory coupled to the processor and configured to store program instructions executable by the processor to implement a method that includes receiving a request for caddie services at one or more tee times over a network. From information stored in a database about two or more caddies, one or more caddies are selected for performing caddie services for the tee times. Over the network, an acceptance or rejection for the assignments for the tee times is received from the selected caddies.

In an embodiment, a tangible, computer readable medium includes program instructions are that computer-executable to implement a method that includes receiving a request for caddie services at one or more tee times over a network. From information stored in a database about two or more caddies, one or more caddies are selected for performing caddie services for the tee times. Over the network, an acceptance or rejection for the assignments for the tee times is received from the selected caddies.

In an embodiment, a method includes storing, in a memory of a computer system, information relating to two or more caddies and criteria for selecting caddies for a plurality of time slots. From the information stored about the two or more caddies and the criteria for selecting caddies, one or more caddies are selected to perform caddie services for at least one time slot.

In an embodiment, system includes a processor and a memory coupled to the processor and configured to store program instructions executable by the processor to implement a method that includes storing, in a memory of a computer system, information relating to two or more caddies and criteria for selecting caddies for a plurality of time slots. From the information stored about the two or more caddies and the criteria for selecting caddies, one or more caddies are selected to perform caddie services for at least one time slot.

In an embodiment, a tangible, computer readable medium includes program instructions are that computer-executable to implement a method that includes storing, in a memory of a computer system, information relating to two or more caddies and criteria for selecting caddies for a plurality of time slots. From the information stored about the two or more caddies and the criteria for selecting caddies, one or more caddies are selected to perform caddie services for at least one time slot.

### BRIEF DESCRIPTION OF THE DRAWINGS

FIG. 1 illustrates one embodiment of a caddie management system connected to user devices over a network.

FIG. 2 is a diagram illustrating features/processes that each user level has access to within the system.

FIG. 3 illustrates one embodiment of a shift flow in a caddie management system.

FIG. 4 illustrates one embodiment of a shift flow with ranking criteria applied in a caddie management system.

FIG. 4A illustrates one embodiment of a view of a full time rotating schedule.

FIG. 4B is a table illustrating one embodiment of a Priority History list for consecutive days of work for one group.

FIG. 4C is a table illustrating one embodiment of a daily schedule determined from a priority history.

FIG. 4D illustrates one embodiment of a monthly loop times table.

FIG. 4E illustrates screens for the day before, caddie group shift time schedule.

FIG. 4F illustrates a caddie shift start block table for implementing a preschedule builder start time/group.

FIG. 5 illustrates one embodiment of a set of display screens for a caddie management system.

FIG. 6 illustrates one embodiment of caddie training using a caddie management system.

FIG. 7 illustrates one embodiment of a screen for providing and maintaining contact and qualification information.

FIG. 8 illustrates one embodiment of a screen for creating new events.

FIG. 9 illustrates one embodiment of screen for managing shifts for events.

FIG. 10 illustrates one embodiment of a screen for adding a tee time.

FIG. 11 illustrates one embodiment of a screen for viewing and managing shifts scheduled for a caddie.

FIG. 12 illustrates a screen for entering and reviewing post round wrap up information.

FIG. 13 illustrates a schedule of payments display.

FIG. 14 illustrates a screen for managing and reviewing billing for caddie services in a caddie management system.

FIG. 15 illustrates a screen for managing caddie services on a caddie management system by geographic area.

FIG. 16 illustrates a screen for managing caddie services on a caddie management system by course.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

FIG. 1 illustrates one embodiment of a caddie management system connected to user devices over a network. System 100 includes caddie management system 102 and user devices 104. User devices 104 access caddie management system 102 by way of network 106. Caddie management system 100 is connected to club/resort systems 105 at any number of a clubs, resorts, or other facilities or properties including golf courses or other amenities.

In various embodiments, a system (such as system 100) provides program management for caddie tee time and non-tee time scheduling and booking, course training, on-site caddie master check-in systems, caddie alerts, inter-team messages, and tournament and event loop management. The system may recommend the highest rated caddies available for a client's tee time. In some embodiments, the system is integrated with a website or point of sale system of a club or service provider.

In some embodiments, a system provides automatic booking of the most qualified caddies by availability. The system may provide smart phone-compatible tee time requests and user management. In some embodiments, the system includes a team notification and messaging system.

User devices 104 may be portable electronic devices. User devices 104 may be connected with one another and with caddie management system 102 by way of network 106. Examples of portable electronic devices 104 include a smart phone, a tablet computer, or a pager. User devices 104 may enable communication, task management, and reporting between one another and between other systems on network 106.

User devices 104 may be connected to the network over any suitable medium, such as electrical or optical cable, or via any suitable wireless standard such as IEEE 802.11 (“Wi-Fi”), IEEE 802.16 (“WiMax”), or cellular network.

Although for illustrative purposes only a single notebook computer and two portable electronic devices are shown in FIG. 1, a system may in various embodiments have any number, and any of various types, of portable or fixed electronic devices. In some embodiments, a user device 104 may be a fixed workstation (for example, a PC in the home of a parent).

Caddie management system 102 includes one or more processors 122, system memory 124, and data storage device 126. Program instructions may be stored on system memory 124. Processors 122 may access program instructions on system memory 124. Processors 122 may access data storage device 126. Users may be provided with information from caddie management system 102 by way of monitor 128. Users interact with computer system 120 by way of I/O devices 130. An I/O device 130 may be, for example, a keyboard or a mouse. Caddie management system 102 may include, or connect with, other devices 136. Elements of computer system 120 may connect with other devices, such as computer systems in stores 104, by way of network 106 and network 108 via network interface 132. Network interface 132 may be, for example, a network interface card.

In some embodiments, a system is used for managing services for providing caddies to golfers at resorts and clubs. The system may also provide tournament planning, event management, online marketing services and caddie services for corporate, charity and competitive golf tournaments.

In some embodiments, a system integrates with clubs/resorts golf management systems. In certain embodiments, resorts may be set up to transfer (for example, FTP) information on a periodic basis to reflect any current or new reservations changes to their Golf management system regarding caddies. An import may provide a system with reservation number/player name, what course, how many players and if the guest wants a forecaddie or bag caddie. The import may also receive information on whether the resort has billed the correct amount of players and in turn sends a double or triple check report to the pro in charge or anyone associated with billing what the system billed as compared with what the club or resort billed.

In some embodiments, a system automates caddie selection and loop fulfillment. Once the system receives the reservation information, a TBD caddie box may be created. A drop down box of all qualified caddies (by course) may be presented and caddie is selected. Once a qualified caddie is selected, a display screen may indicate status (for example, the box may be turned to the color red.)

In some embodiments, a system automates loop reminders/updates to caddies. A reminder email message may be sent the day before the loop is scheduled to each caddie. In some cases, a tee time in the resort's reservation system (the club's golf management system) is changed due to time, player count or cancellations. The system may send a change or cancel email to the scheduled caddie and ask “can you do the new time” or if it is not a time that was in the caddie's availability time frame. The caddie either accepts or rejects and the system records the caddie's decision and notifies the caddie master if a new caddie needs to be assigned. If the system receives a cancellation/change email less than 24 hours, an email is not sent to the caddie.

In some embodiments, a system manages post round wrap-ups. After a loop is completed, a post round wrap-up (PRWU) is completed each caddie with the confirmed player count, tee time and any important information (e.g. notes) that needs to be documented for future use by the system or the resort/club.

In some embodiments, each caddie has a personal account online to manage his schedule, contact information (e.g. address change) future and past loops, compensation, uniform order access, emergency contacts, communication with the company, tee time requests and a short term availability option to be contacted for a short term loop. Each caddie may be required to complete the PRWU through the personal site in order to receive payment. Important company info can also be posted on the caddie's personal site.

In some embodiments, a caddie management system manages recruiting, applications, phone and face interviews, on-course training, shadow loops, background checks, accounting, legal documents, and the time, date, and specific notes on each process. Each caddie may be an independent contractor to the club or resort. The system may require all reservation requests to be accepted or rejected by the independent contractor. Late fees, show/sick fees may be assessed and/or enforced by the system.

In some embodiments, the system organizes the invoices by club and course so the accounting department can expense correctly. The system may break up the reservation fee from the service charge fee and bills our clubs accordingly with two separate invoices and ticket numbers to back up all charges.

Payments for independent contractors/onsite managing ours may be done through the system on a periodic basis (for example, bimonthly). The first step is to process a Pay Caddie report for that pay period. The report may be checked for no-show/late/uniform purchase/repayment of training fees. Once accounting has approved the pay period, the system may automatically upload all information for each contractor/vendor account. Items may be expensed to the correct chart of accounts. The system may then print checks and mail them to the caddies. In some embodiments, a system ensures compliance with State and Federal workforce requirements providing clubs/resorts with world class caddie services.

In some embodiments, booking, scheduling, and related services are provided to multiple golf courses to as a software-as-a-service model. A system may allow resorts and clubs to register, subscribe and use the software to manage their caddie programs and services.

In some embodiments, different users in a caddie management system receive different levels of access. FIG. 2 is a diagram illustrating features/processes that each user level has access to within the system. Each of Caddie View Actions 140, Caddie OSM 142, Caddie Master 144, and Admin 146 may have a different set of features and processes. The administrative user may have full access to all features within the system.

FIG. 3 illustrates one embodiment of a providing shift flow in a caddie management system. A caddie may be assigned a shift at 160. The caddie management system may send out an email at 162, SMS at 164, and, if the caddie has set the preference to an auto call (generated voice), to the caddie's mobile number at 166. If the caddie ACCEPTS the shift at 168, they may be marked as confirmed in the system at 170, notified via email, SMS and/or alert at 172 and a calendar invite at 174. Follow-up SMS, Email, Auto-call may be issued and scheduled to reach the caddie within a configured time before the scheduled shift. If the caddie rejects the shift at 176, the shift is re-queued at 178.

In some embodiments, a system selects one or more caddies from a database. The selection may be made based on one or selection criteria. One or more selection filters may be applied to select a caddie for each tee time. In one embodiment, a caddie management system applies rating or ranking criteria to determine a caddie to be offered an assignment. FIG. 4 illustrates one embodiment of a shift flow with ranking criteria applied in a caddie management system. In the flow illustrated in FIG. 4, a shift is added at 200 to a database 202. A query is made for all caddies approved for a course at 204. At 206, 208, 210, and 212, a series of filters are applied to the set of approved caddies. For example, a filter is applied based on a caddie's rating at 210. A caddie ranking system may assign each caddie a numerical rating or ranking (for example, 1 to 4). The applied rating may be an overall ranking for a caddie, for specific criteria relating to the shift (for example, the caddie's experience on the particular course, or a combination thereof Information the caddie's recent caddie activity (or the caddie's projected activity at the time of the shift) may also be applied to determine whether a particular caddie will be offered the shift. For example, if a caddie will have worked three consecutive previous shifts at the time of the shift to be assigned, that caddie may be bump ed in favor of a different caddie. In some embodiments, a rotation system is used to determine which caddie within a group of caddies will be offered a shift. In some embodiments, caddie performance history is managed via a remote portal.

In some embodiments, the system selects a caddie based on caddie qualification level (which may be based on training completed, credentials, a caddie's rating by the caddie's previous clients), availability, rotation fairness criteria for a group or population of caddies, or a combination of such factors and criteria. In some embodiments, two or more factors are weighted against one another for each candidate caddie to select the caddie for one or more specific shifts. For example, to select among a group of candidate caddies, each caddie may be given a composite score based on a weighted factor for qualifications/rating and another weighted factor for rotation fairness. For the rotation fairness value, for example, a lower value may be given if the caddie just worked a shift and a higher value if the caddie has not worked a shift for a long time.

At 214, an entry may be chosen for a first attempted assignment. At 216, a notification may be issued and/or scheduled (for example, by SMS, email, and/or auto-call). The notification may be made, or scheduled to be made to reach the caddie by a designated time. If the caddie accepts the shift at 218, the shift assignment is finalized at 220. If the caddie rejects the shift at 222, the algorithm is repeated at 224 so that a different caddie can be selected and confirmed.

In some embodiments, a threshold is applied for one or more factors in determining a caddie for a shift. Each threshold may be a maximum threshold or a minimum threshold. For example, a threshold may be set such that a caddie does not receive a shift if the caddie has reached a maximum threshold for a preceding period (for example, threshold that the caddie has worked 4 shifts in the last three days). As another example, a threshold may be set such that a caddie does not receive a shift if the caddie has a quality rating that is below a predetermined minimum threshold (for example, below a 3 on a 5 point scale) or a shifts acceptance level that is below a predetermined threshold (for example, accepted less than 75% of shifts in the previous two week period).

In certain embodiments, caddie selection is based on a combination of thresholds and numerical scores. For example, for a group of caddies, a threshold may be applied to remove any caddies having a rating below a threshold. Each of the caddies that pass the rating threshold may be given a score based on caddie other criteria, such as availability, rotation fairness, or both.

In some embodiments, the system builds the Daily Schedule utilizing the Monthly schedule and the Priority History. The Daily Schedule lists the order of the Report times for the Contractors. It is built primarily from the Monthly Schedule. The Monthly Schedule may be built of M Groups of N Contractors per group. In one embodiment, a Monthly Schedule is built of 3-7 Groups of 3-7 Contractors per group. There may be multiple monthly schedules viewable to a user. The multiple month schedules may be consecutive or non-consecutive. In one embodiment, two consecutive Monthly Schedules are viewable at all times.

FIG. 4A illustrates one embodiment of a view of a full time rotating schedule. In this example, the Schedule may be an A-B-C-D (E-F-G) rotating Shift Report Block scheduler to provide 6-7 days a week, 7 AM-3 PM coverage, with each date associated with one of columns 242 in the table. The Monthly Schedule may be partitioned into Rotating Shift Report Blocks (7:00, 9:00, 11:00, 1:00), with each Report Group progressing from the 7:00 to the 1:00 Shift Report Block consecutively (each report block having a cell 244 on each date). The Daily Schedule may be staffed through input from a manager user, automatically by rules implemented by the system, or a combination of both. In one embodiment, the Closing manager staffs the Daily Schedule by viewing the Monthly Schedule and populating the Daily Schedule. In some embodiments, the Closing Manager schedules over a network (for example, by way of a remote computer, mobile phone, or other portable electronic device).

In some embodiments, the Daily Schedule is determined based on a Calendar of Requests, a Guest Registry, and a Priority History. The Calendar of Requests specifies which caddies have Member requests for the next day and the following day as well. The Guest Registry is provided daily by the pro Shop by end of day and lists all registered guests of the club for the following day. The Priority History is a list of each Report Group's “Priority” in their group. As each caddie works, they move to the bottom of the group's priority.

FIG. 4B is a table illustrating one embodiment of a Priority History list for three consecutive days of work for one group. Table 260 includes a column for each day. The shading indicates whether a caddie worked on Request (vertical hatch as reflected at 262) or worked a General Public loop (forward hatch as reflected at 264). In this arrangement, if a caddie receives work, that caddie goes to the bottom of his or her group thereby distributing the work and allowing more people more of a chance to work. Exceptions may be made if the caddie receives a Request or is picked off the Daily Schedule—the list of available caddies for the day. In the caddie scheduling illustrated in FIG. 4B, the first day saw Chris, John, and Mark either receive a request or get picked off the Daily Schedule. Since the others (no hatch) did not work no changes are made to the group's priority. The second day saw Chris receive another request and Matt, John, Mark and Thomas work a General Public loop. This moves Matt, John, Mark, and Thomas to the bottom of their group (while staying in their respective positions), while Bobby, Chris, and Jason (who didn't work), are the first three caddies available in their group. From here, the Daily Schedule may be populated according to the Shift Report Block and Priority History, omitting anyone who has the day off.

Daily demand varies, so each Report Block may be assigned specific report times by 9 PM each day for the following day's report times. In some embodiments, the Opening Manager populates the Daily Schedule that the Closing Manager built the day before.

In one embodiment, the system operates based on the following conditions and rules:
1. The 7:00 Report Block names are listed, according to the Current Priority and omitting those that are scheduled off
2. Each Report Block is treated the same until all available caddies are scheduled
3. The Opening Manager assigns report times utilizing current demand (tracked on Monthly Loop Times table/sheet) and any additional groups that appeared on the Guest Registry
4. If demand will be light, some caddies will be put “On Call,” (for example, they have must keep their phones on them in case they are called in to work. Each caddie may have their own specific, agreed upon travel time in which they must report.

FIG. 4C is a table illustrating one embodiment of a daily schedule determined from a priority history. In table 270, each time slot has one or more caddies assigned by the system.

FIG. 4D illustrates one embodiment of a monthly loop times table. Table 280 includes columns 282 corresponding to the number of loops per hour. Each of rows 284 corresponds to a specific date.

FIG. 4E illustrates screens for the day before, caddie group shift time schedule. Screen 288 displays a caddie pick sheet. Screen 292 may be displayed over a network on a caddie manager's personal electronic device, such as a mobile phone. Screen 292 is a caddie shift start time screen. Screen 292 may be displayed over a network on a caddie's personal electronic device, such as a mobile phone. The user may slide hour, minutes, a/p on screen to choose the appropriate time for caddie shift to begin.

FIG. 4F illustrates a caddie shift start block table for implementing a preschedule builder start time/group. Screen 296 may be displayed over a network on the user's personal electronic device, such as a mobile phone. The user sets the group start time in right column down to last caddie name/group. Then user then uses the Build action button to expand the rotation schedule out N months from current edited date. In some embodiments, rows clone and rotate time. Times may be rotated by the club configured shift start block duration each day by the start time in the third column. For example, if Row 1:3 was 07:00 am, then the next day (Row 1:4) would be 09:00 am.

In one embodiment, users access the system by one or more display screens. FIG. 5 illustrates one embodiment of a set of display screens for a caddie management system. In this example, the screens include:
Dashboard 300, a centrally located screen aggregates coordination details.
Create Tournament 302 and Create Event 304 screens allow for proper data capture to plan, schedule and assign shifts for courses.
Event calendar 306 is used to assign caddies to tee-times and golfers.

In some embodiments, a caddie training process flows from an external application to a trained onboarded caddie. Using the system, a caddie may proceed through a Caddie Assessment Test, the Caddie Customer Service Training and the On Course Training FIG. 6 illustrates one embodiment of caddie training using a caddie management system. A caddie may submit an application at 320. An interview may be conducted by phone at 322, face-to-face 324, or both. If the interview is favorable, a caddie assessment test is administered at 326. Service training is conduct at 328 and on course training at 330. Once this training has been completed, the caddie may be shadowed (for example, by an instructor or senior caddie) at 332. Once training is complete at 334, the caddie is available for shifts at 336.

In some embodiments, a caddie maintains the caddie's qualifications and contact information by way of screen in a caddie management system. FIG. 7 illustrates one embodiment of a screen for providing and maintaining contact and qualification information. Screen 340 provides input fields for personal information, selection boxes for course qualifications, and an activity panel. The information panel includes statistics for the caddie, such as the number of completed loops, upcoming loops and tardies.

In one embodiment, a caddie management system includes the functionality described below.
GOA: Gratuity on Account
GTM: Gratuity To Masters
GTC: Gratuity to Caddie
CFA: Copy from Above
OSM: On Site Manager
Associate Caddie: Means a caddie who is an apprentice and is learning from a professional caddie.
Pay Caddie: A record showing what the caddie should be paid.
Res Fee: Reservation Fee
Service Charge: Fee charged to Club by caddie arrangement service provider
Forecaddie: Non-Carry Caddie (1-5 golfers)
Bag Caddie: Bag Carry Caddie (1-2 golfers)
R: Reservation Charges, appears in Billing sections
MG: Management Fee, appears in Billing sections
SC: Service Charge, appears in Billing sections
CM: Caddie Master
1. Caddie User Dashboard
   a. Views:
      i. User Notices
         1. Fields: Dismiss button for non-critical notices
         2. Notes: Different User Notices highlighted by color based on the level of information
      ii. Required Reads (Training Program)
         1. Fields:
            a. Link with name of document
      iii. Scheduled Shifts
         1. List of shifts that the caddie visitor is assigned to
            a. Fields:
            i. Accept
            1. Displays schedule details
            2. Sends an email to the user with a calendar attachment to enable the System visitor to read it on their mobile phone and add the shift to their mobile phone calendar
            ii. Reject
            i. Prompt for why the System visitor rejects schedule.
            iii. Post-Round Wrap Up—enables the caddie end user to input data showing the caddie finished one or more rounds of golf (round of golf being 9 holes) with golfers and a summary description to the caddie master.
         1. Fields:
            a. Tournament Name
            b. Last name of golfers, comma separated
            c. Number of Golfers
            d. GOA
            e. GTM
            f. OSM
            g. Starter
            h. Hole
            i. Exact Tee Time
            j. User Comments
      iv. Caddie Pay Information
         1. Notes: Shows pending pay period payment. System may not accept monetary payments.
         2. System Billing Functionality.
            a. System enables exports of any participating golf course for any valid date range (current to past)
            b. System exports caddie information for any valid date range (current to past)
            c. System incorporates expenses incurred by caddies (e.g., uniform purchase requests, reimbursement requests). These expenses may be automatically imported into account details so the payments are properly adjusted.
      v. Availability
         1. General Availability
            a. Fields:
            a. Day of Week—Start Hour
            b. Day of Week—End Hour
            a. Note: Display 7 days of the week
         1. Short Term Availability. Caddie can declare dates and times of his/her availability.
            a. Need Company Uniform
            1. Order form
            a. Fields:
            i. Product Options
            ii. Add to Order
            iii. Place Order
            b. Notes: Display that this will be deducted from their caddie pay on the next pay period so no funds are needed at point of order.
            b. Personal Information Details
            1. User Contact Details
            a. Fields:
            i. First Name
            ii. Last Name
            iii. Address (Street, City, State, Zip)
            iv. Contact (Phone, Mobile, Pager)
            1. Mobile Required for short message service (“SMS”) messages
            2. Opt-in to receive SMS messages
            v. Request Course & Area Updates
            b. Notes:
            i. Displays the caddie end user's approved course and other golf course locations where the caddie can sign up and be available.
            2. Emergency Contact Details
            a. Fields:
            i. First Name
            ii. Last Name
            iii. Address (Street, City, State, Zip) Contact
            iv. Relationship
            c. Knowledge base—Support Tickets
            1. Search existing information
            2. Send a support ticket to site manager or golf course caddie manager.
            3. Send a tech support ticket to help desk
      ii. Admin User Dashboard (master controls/super admin mode)
         a. Billing
         a. Background Check—Link to a 3^{rd} Party provider for running background checks. (the URL is configurable by admin)
         b. View Imports
            i. Links to downloads of raw data import from golf courses.
         e. Data Log Report (Cross-Over Report) shows when a data import of the a golf course's external software was processed and key action items that happened. May incorporate a time stamp.
            i. Fields
            1. Date of Action
            2. Line item of Action (Example: Tee-time Created)
         f. On site manager (OSM) (If user permitted) who will check in caddie and sign off on time sheets.
            i. Date of OSM
            ii. Course
            iii. Email
            iv. Phone
         g. On site manager display—Shows who is signed up as OSM for current day and which course, if relevant, is assigned to caddie
         h. Upcoming Shifts
            i. Link to schedule day
            ii. Displays
      iii. Tournaments
         a. Add|Edit
            i. Fields:
            1. Start Date;
            2. Start Time;
            3. Name;
            4. Course;
            5. Start Type; and
            6. Active.
            ii. Update Numbers Fields:
            1. Groups
            2. # of Players
            3. # Locked In
            4. GTM
            5. GTM type
            6. Notes
            iii. Notes: Displays the history of the tournament editing
      iv. Account Details
         a. Edit
      v. Send Message
      vi. Dashboard
      vii. Create Event
      viii. Create Tournament
      ix. Schedule (Calendar View)
      x. Upcoming Events
      xi. Training Tracker Multiple profile statuses
      xii. Application System
         a. New Appointment
         b. Needs Phone Interview
         c. Needs Face-to-face Interview
         d. Needs On-course Training
         e. Needs To Shadow
         f. Caddie
         g. Out of Office
         h. Not Accepted
      xiii. User Information
         a. Add|Edit
      13. Company (Club)
         a. Add|Edit
         b. Locations (Courses)
         c. List Entailing the golf club name and areas it operates in.
      14. Accounting (Billings)
         d. Pay User (Pay to Caddie) Caddie end user can input data on whether he/she was paid by the golfer.
         e. Invoicing to Company (Clubs)
      15. Caddies have the option of selecting short-term availability status
      16. Club User Dashboard
         a. View upcoming schedule
         b. List of upcoming tee-times
         c. Request removal tee-time (alert is sent to CM)
      17. Document Library enabling golf course caddie managers to upload caddie program documents to the document library
      18. Open Shifts
      19. Admin Uniform Inventory
         a. Add/Edit Product
            i. Fields:
            1. Product Name
            2. Price
            3. Cost
            4. Inventory Count
            5. Attributes (size, etc.)
      20. Emails
         a. Shift Scheduled
         b. Shift Available
         c. Shift Alert
      21. Text Messages
         a. Shift Scheduled
         b. Shift Available
         c. Shift Confirmed
         d. Shift Alert
      22. Caddie User management
         a. Caddie User Admin (passwords, roles, contact updates)
         b. Caddie User Self Service
            i. Account settings (passwords, contact info, availability)
            ii. Availability
            iii. Training Materials
            iv. Uniform requests
            v. Submit for training at new course. May show the caddie obtained the necessary training for a particular golf course.
            vi. Post Round Wrap Up. Functionality enabling the caddie to summarize the number of rounds and other details for rounds finished.
         c. Caddie Availability integration
            i. Manually available short-notice
            ii. Automated assistant to find available schedules
         d. Caddie inter-communication methods (SMS, Emails, Newsletters, Updates)
            i. May include application programming interface (“API”) for application email delivery
            ii. cloud based telecom.
            iii. Newsletter delivery
         e. Caddie Schedule Admin
            i. Automated delivery of shift ACCEPT/REJECT
            ii. Automated alert on REJECT for mitigation of unclaimed shift
            iii. Queuing of Caddies
            a. Stack desired caddies in a shift; first caddy to confirm wins the open slot allowing remaining caddies to opt for other shifts or return to open availability.
            b. 4 rounds/week for rotation system preferred by Caddie Rating The Caddie Rating means an algorithm rating methodology for caddies to determine their position queue of when they can be a caddie on a particular golf course during a particular time period. Algorithm sorts the queue based on criteria set by a user (for example, the System super administrator.)
            i. Based on scheduled round
            ii. Save slot for unexpected round
            iii. Determine how many walk-ups course would obtain
      23. Document Library—Required caddie program reading materials for participating caddies.
         a. Online secure storage of content for sharing
         b. Required reading can be defined, assigned and tracked
         c. Newsletters can be authored and delivered through document library
      24. Event Admin
         a. Create an event
            i. Recurrence and Event templates
            ii. Calendar integration
            iii. application tracking
            iv. Event level override of Club information
            v. (Billing details, GTM, GOA and discount rate.)

FIG. 8 illustrates one embodiment of a screen for creating new events. Screen 360 includes input fields and menus (for example, drop down menus) for enter information about a new event. Once the new event has been created, a user may view and manage shifts for the event.

FIG. 9 illustrates one embodiment of screen for managing shifts for events. Shift screen 380 date menus, calendars, and shift listing. A specific date for a shift may be selected on the calendar. Each item in the shift listing may be edited to include the information need to assign the shift.

FIG. 10 illustrates one embodiment of a screen for adding a tee time. Shift screen 340 includes drop-down menus and input fields for a tee-time. The caddie or other users may view the caddie's shifts schedule, including all tee times and for all events in which the caddie is scheduled to participate.

FIG. 11 illustrates one embodiment of a screen for viewing and managing shifts scheduled for a caddie. Screen 420 includes a confirmed shift panel, new shift accept/reject panel, short term availability panel, and post round wrap up panel. The caddie may enter information in input fields or menus in the short term availability and post round wrap up panels. In some embodiments, a caddie views and provides information using a portable electronic device, such as a smart phone.

After a round has been completed, a caddie may enter post round wrap up information, which may be reported and stored in the system. FIG. 12 illustrates a screen for entering and reviewing post round wrap up information. On screen 440, the user can view and edit listings of post-round wrap ups by date, date range, course, or combinations thereof.

FIG. 13 illustrates a schedule of payments display. Screen 460 may include a listing of payments for the caddie by date, with cumulative totals for a time period (for example, year-to-date).

FIG. 14 illustrates a screen for managing and reviewing billing for caddie services in a caddie management system. Screen 480 allows a user to display a listing a billings by date, date range, club, course, or combinations thereof.

In some embodiments, a user manages and views caddie services for different courses by physical area (for example, geographic region by geographic region) or other grouping. FIG. 15 illustrates a screen for managing caddie services on a caddie management system by geographic area. Screen 500 is a top-level area screen that allows a user to select, edit, and add areas associated with one or more courses.

In some embodiments, a user manages and views caddie services by club resort, by course, or both. The user may manage and review information for any number of clubs, resorts, and courses. FIG. 16 illustrates a screen for managing caddie services on a caddie management system by course. Screen 520 is a top-level course screen that allows a user to create events and manage shifts and events for a selected course.

In some embodiments, a service provider provides services to participants by way of cloud computing resources. In some embodiments, computation resources are rented or leased to customers of a service provider. In certain embodiments, services are provided to users at sites as software as a service (“SaaS”) or platform as a service (“Paas”). Services may be provided to each user on an on-demand basis.

Networks employed in embodiments described herein may include any suitable data network or combination of networks that enable the exchange of information between electronic systems. For example, networks 106 described in FIG. 1 may include one or more Local Area Networks (LANs) such as Ethernet networks, as well as Wide Area Networks (WANs), Metropolitan Area Networks (MANs), or other data or telecommunication networks implemented over any suitable medium, such as electrical or optical cable, or via any suitable wireless standard such as IEEE 802.11 (“Wi-Fi”), IEEE 802.16 (“WiMax”), etc. In various embodiments, all or a portion of networks 106 may include the network infrastructure commonly referred to as the Internet. In other embodiments, networks may be entirely contained within an enterprise and not directly accessible from the Internet. In certain embodiments, information may be exchanged over a virtual private network. In one embodiment, information is exchanged over the internet, but encrypted in such a way to make a private network not accessible from the rest of the internet.

Computer systems may, in various embodiments, include components such as a CPU with an associated memory medium such as Compact Disc Read-Only Memory (CD-ROM). The memory medium may store program instructions for computer programs. The program instructions may be executable by the CPU. Computer systems may further include a display device such as monitor, an alphanumeric input device such as keyboard, and a directional input device such as mouse. Computer systems may be operable to execute the computer programs to implement computer-implemented systems and methods. A computer system may allow access to users by way of any browser or operating system.

Computer systems may include a memory medium on which computer programs according to various embodiments may be stored. The term “memory medium” is intended to include an installation medium, e.g., Compact Disc Read Only Memories (CD-ROMs), a computer system memory such as Dynamic Random Access Memory (DRAM), Static Random Access Memory (SRAM), Extended Data Out Random Access Memory (EDO RAM), Double Data Rate Random Access Memory (DDR RAM), Rambus Random Access Memory (RAM), etc., or a non-volatile memory such as a magnetic media, e.g., a hard drive or optical storage. The memory medium may also include other types of memory or combinations thereof. In addition, the memory medium may be located in a first computer, which executes the programs or may be located in a second different computer, which connects to the first computer over a network. In the latter instance, the second computer may provide the program instructions to the first computer for execution. A computer system may take various forms such as a personal computer system, mainframe computer system, workstation, network appliance, Internet appliance, personal digital assistant (“PDA”), television system or other device. In general, the term “computer system” may refer to any device having a processor that executes instructions from a memory medium.

The memory medium may store a software program or programs operable to implement embodiments as described herein. The software program(s) may be implemented in various ways, including, but not limited to, procedure-based techniques, component-based techniques, and/or object-oriented techniques, among others. For example, the software programs may be implemented using ActiveX controls, C++ objects, JavaBeans, Microsoft Foundation Classes (MFC), browser-based applications (e.g., Java applets), traditional programs, or other technologies or methodologies, as desired. A CPU executing code and data from the memory medium may include a means for creating and executing the software program or programs according to the embodiments described herein.

As used herein, a “communications network” refers to a system including one or more communication channels (for example, lines, satellite frequency, or radio waves) interconnecting one or more nodes (for example, servers, routers, computers, or communication devices). Examples of a “communications network” include the internet, a cellular telephone network, a local area network (LAN), or a wide area network (WAN).

Many of the above description and figures above relate to systems and processes for managing caddie services or other services provided at a course, club, or resort. Systems and processes such as those described herein may nevertheless in various embodiments be used to manage any of various other labor services. Examples of services that may be managed using systems and methods as described herein include trucking, package delivery, food delivery, valet services, restaurant services, catering, event-support (for example, concert staffing), security, nursing, in-home care, landscape services, and personal services.

In an embodiment, a method includes receiving, over a network, a request for services at one or more times, determining, from information stored in a database about two or more persons, a selection of one or more persons to perform at least a portion of the services for at least one of the times; and soliciting, from at least one of the selected persons, over a network, an acceptance or rejection of an assignment of one or more of the times.

In an embodiment, a method includes receiving, over a network, a request for services at one or more times, determining, from information stored in a database about two or more persons, a selection of one or more persons to perform at least a portion of the services for at least one of the times. The selection by the system is based at least in part on rotation fairness criteria.

In an embodiments, a method includes storing, in a memory of a computer system, information relating to two or more candidates to provide a service; storing, in a memory of the computer system, criteria for selecting one or more of the candidates for a time slot; and determining, by the computer system, from at least a portion of the information stored about the two or more candidates and at least a portion of the criteria for selecting the candidates, one or more persons to perform the services for at least one time slot.

The systems and methods as described herein may be used to manage services provided by employees, independent contractors, or hybrid personnel (for example, part independent contractor, part employee). As an example, the system may enable a user to manage assignments to a caddie who does some of her work as an employee of a caddie service provider company and some of her work as an independent contractor. As an example, the system may enable a user to manage assignments to a caddie who does some of her work as an employee of a club, and part of her work as an independent contractor. In certain embodiments, a system manages assignments of a person both before and after a transition from employee to independent contractor, or from independent contractor to employee.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Methods may be implemented manually, in software, in hardware, or a combination thereof. The order of any method may be changed, and various elements may be added, reordered, combined, omitted, modified, etc. Changes may be made in the elements described herein without departing from the spirit and scope of the invention as described in the following claims.

1. A method, comprising:
receiving, over a network, a request for caddie services at one or more tee times;
determining, by a computer system, from information stored in a database about two or more caddies, a selection of one or more caddies to perform at least a portion of the caddie services for at least one of the tee times; and
soliciting, from at least one of the selected caddies, over a network, an acceptance or rejection of an assignment of one or more of the tee times.

2. The method of claim 1, wherein the determination of at least one of the selected caddies for at least one of the tee times is based on the assigned caddie's recent services.

3. The method of claim 1, wherein the determination of at least one of the selected caddies for at least one of the tee times is based on priority among two or more caddies for which information is included in the database.

4. The method of claim 1, wherein the determination of at least one of the selected caddies for at least one of the tee times is based on at least in part on a rating for the caddie.

5. The method of claim 1, wherein requests for caddie services for two or more courses are received over the network, wherein the determination of caddies to perform services includes allocating two or more caddies in the database over at least two of the courses.

6. The method of claim 1, wherein determining the selection of one or more caddies comprises applying one or more selection filters.

7. The method of claim 1, wherein determining the selection of one or more caddies comprises applying one or more selection filters, wherein at least one of the selection filters applies at least one of the rating criteria or an availability criteria.

8. The method of claim 1, wherein determining the selection of one or more caddies comprises applying one or more selection filters, wherein at least one of the selection filters applies rotation fairness criteria.

9. The method of claim 1, wherein at least one of the caddies is an independent contractor and at least one of the caddies is an employee.

10. The method of claim 1, wherein at least one of the caddies receives some assignments from the system as an independent contractor and other assignments from the system as an employee.

11. A system, comprising:
a processor;
a memory coupled to the processor and storing program instructions executable by the processor to implement:
receiving, over a network, a request for caddie services at one or more tee times;
determining, by a computer system, from information stored in a database about two or more caddies, one or more caddies to perform at least a portion of the caddie services for at least one of the tee times; and
soliciting, from at least one of the selected caddies, over a network, an acceptance or rejection of an assignment of one or more of the tee times.

12. (canceled)

13. A method, comprising:
storing, in a memory of a computer system, information relating to two or more caddies;
storing, in a memory of the computer system, criteria for selecting caddies for a plurality of time slots; and
determining, by the computer system, from at least a portion of the information stored about the two or more caddies and at least a portion of the criteria for selecting caddies, one or more caddies to perform caddie services for at least one time slot.

14. The method of claim 13, further comprising soliciting, from at least one of the selected caddies, over a network, an acceptance or rejection of an assignment of one or more of the time slots.

15. The method of claim 13, wherein the determination of at least one of the selected caddies for at least one of the time slots is made by applying one or more availability criteria.

16. The method of claim 13, wherein the determination of at least one of the selected caddies for at least one of the time slots is made by applying one or more caddie quality or ranking criteria.

17. The method of claim 13, wherein the determination of at least one of the selected caddies for at least one of the time slots is made by applying one or more rotation fairness criteria for a group of caddies.

18. The method of claim 13, wherein the determination of at least one of the selected caddies for at least one of the time slots is made by applying a combination of at least two of a rotation fairness criteria, a rating criteria, and an availability criteria, for a group of caddies.

19-21. (canceled)
